(19) United States
(12) Patent Application Publication
(10) Pub. No.: US 2004/0060922 A1
(43) Pub. Date: Apr. 1, 2004

(54) Composite cooking machine

(75) Inventor: Jeon-Hong Kang, Suwon-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/372,173

(22) Filed: Feb. 25, 2003

(30) Foreign Application Priority Data
Sep. 27, 2002 (KR) 2002-58913

(51) Int. Cl. H05B 1/02

(52) U.S. Cl. 219/484; 219/485

(57) ABSTRACT

A composite cooking machine includes a plurality of switches which are connected in series with a plurality of component cooking machines, between a circuit breaker in a home and the component cooking machines, respectively, to selectively supply power to the component cooking machines. A control unit of the composite cooking machine controls the switches so as to supply the power to only one of the component cooking machines, without responding to a key signal for another one of the component cooking machines, where a cooking operation performed by the one component cooking machine has not been completed. Therefore, the composite cooking machine does not allow simultaneous operations of the component cooking machines, and prevents unnecessary operations of the circuit breaker. Accordingly, the reliability of the composite cooking machine is improved.

### CROSS-REFERENCE TO RELATED APPLICATIONS

This application claims the benefit of Korean Patent Application No. 2002-58913, filed Sep. 27, 2002, in the Korean Intellectual Property Office, the disclosure of which is incorporated herein by reference.

### BACKGROUND OF THE INVENTION

1. Field of the Invention

The present invention relates to a composite cooking machine which prevents a plurality of component cooking machines from operating simultaneously.

2. Description of the Related Art

Generally, a composite cooking machine is a product obtained by combining various component cooking machines having different functions into a single machine.

For example, there are various composite cooking machines where another component is added to a microwave oven, such as a microwave oven and coffee maker combination, a microwave oven and toaster combination, a microwave oven and electric range combination, and a microwave oven and air cleaner combination.

FIG. 1 illustrates a conventional composite cooking machine having first and second component cooking machines (L1 and L2) 20 and 30 which perform different cooking functions and are connected to a circuit breaker 10 in a home. Where a plug (not shown) of the composite cooking machine is inserted into a socket (not shown) of the home, the first and second component cooking machines 20 and 30 are supplied with power through the circuit breaker 10, and perform cooking operations under a control of a control unit 40 according to an instruction input through an input unit 50 from a user.

The circuit breaker 10 in the home is designed to shut off the power so as to prevent a fire where a flowing current exceeds a given allowable current of, for example, 15A.

In the conventional composite cooking machine, power consumption is appropriate where any one of the component cooking machines 20 and 30 is used alone. However, where a plurality of component cooking machines are simultaneously operated, that is, where both of the component cooking machines 20 and 30 are operated simultaneously, higher power consumption is required. Therefore, as an excessive current greater than the allowable current flows, the circuit breaker 10 is turned off to shut off the power. Consequently, the conventional composite cooking machine has inconveniences in that the user must recover the circuit breaker and re-operate the component cooking machines 20 and 30 so as to resume the operation.

### SUMMARY OF THE INVENTION

Accordingly, it is an aspect of the present invention to provide a composite cooking machine which can prevent a plurality of component cooking machines from operating simultaneously by not responding to a key signal to operate one of the component cooking machines, where an operation performed by another one of the component cooking machines is not completed.

Additional aspects and advantages of the invention will be set forth in part in the description which follows and, in part, will be obvious from the description, or may be learned by practice of the invention.

To achieve the above and/or other aspects of the present invention, there is provided a composite cooking machine for use in a cooking area, comprising component cooking machines which use a common power source of the cooking area, a power supply unit which individually supplies power to the component cooking machines, an input unit which receives cooking information, and a control unit which controls the power supply unit to operate only one of the component cooking machines in response to the cooking information input through the input unit.

### BRIEF DESCRIPTION OF THE DRAWINGS

These and other aspects and advantages of the present invention will become apparent and more readily appreciated from the following description of the embodiment, taken in conjunction with the accompanying drawings of which:

FIG. 1 is a block diagram of a conventional composite cooking machine;

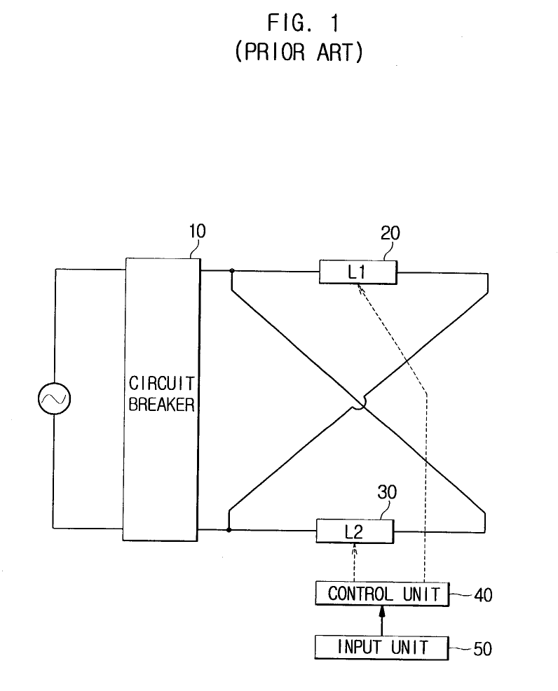

FIG. 2 is a block diagram of a composite cooking machine according to an embodiment of the present invention; and

FIG. 3 is a flowchart illustrating a method of controlling the composite cooking machine shown in FIG. 2.

### DETAILED DESCRIPTION OF THE PREFERRED EMBODIMENTS

Reference will now be made in detail to the embodiment of the present invention, examples of which are illustrated in the accompanying drawings, wherein like reference numerals refer to like elements throughout. The embodiment is described below in order to explain the present invention by referring to the figures.

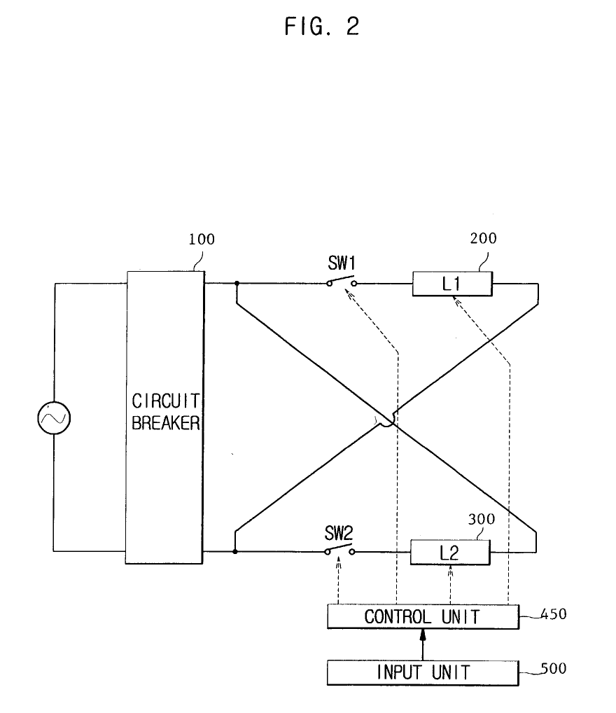

FIG. 2 shows a block diagram of a composite cooking machine according to an embodiment of the present invention. The composite cooking machine of the present invention includes first and second component cooking machines (L1 and L2) 200 and 300 which may be supplied with power through a circuit breaker 100 in a home where a plug (not shown) of the composite cooking machine is inserted into a socket (not shown) of the home. The first and second component cooking machines 200 and 300 may be implemented, respectively, for example, as a microwave oven and a coffee maker, a microwave oven and a toaster, a microwave oven and an electric range, a microwave oven and an air cleaner, or the like.

The present invention includes a control unit 450 that controls the entire operations of the first and second component cooking machines 200 and 300. The present invention further includes first and second switches SW1 and SW2 which are connected in series with the first and second component cooking machines 200 and 300, between the circuit breaker 100 and the first and second component cooking machines 200 and 300, respectively, to selectively supply and shut off power under a control of the control unit 450.

Where a user sets cooking information for one of the component cooking machines 200 and 300 through an input unit 500, an instruction corresponding to the set cooking information is input to the control unit 450. The control unit 450 controls the first and second switches SW1 and SW2 in response to the input instruction to prevent the component cooking machines 200 and 300 from operating simultaneously. The control unit 450 turns on only one of the two switches SW1 and SW2 corresponding to any one of the component cooking machines 200 and 300 being operated, so as to prevent the other component cooking machine from operating.

While the composite cooking machine has been described with two component cooking machines, it is understood that the composite cooking machine may comprise more than two component cooking machines/component operating units, and changes may be made accordingly without departing from the principles of the present invention.

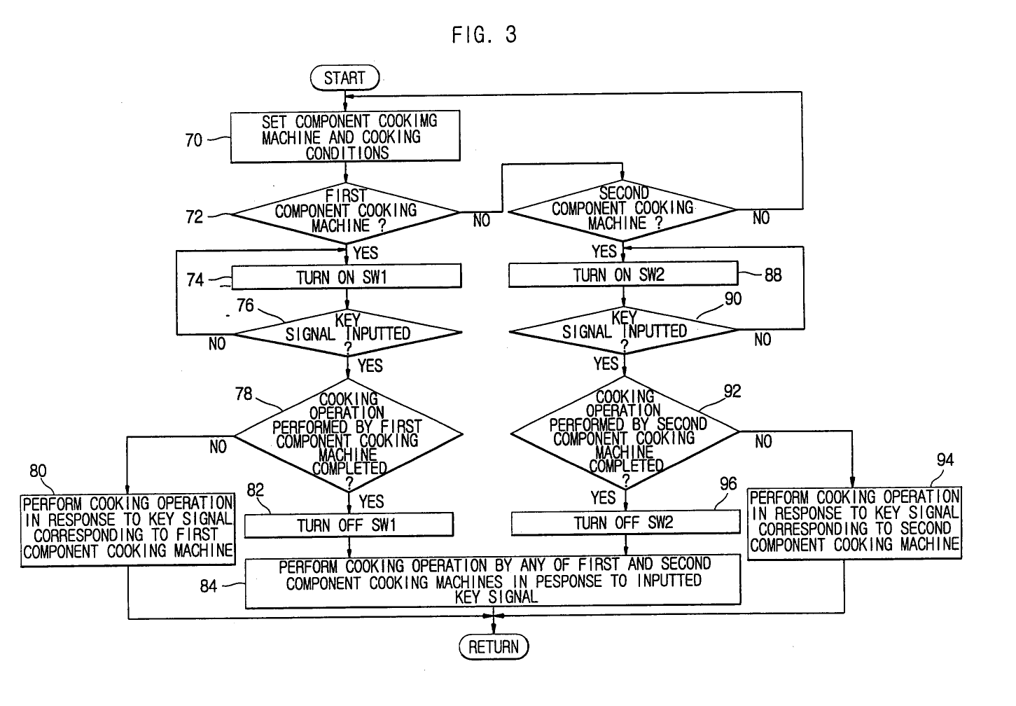

FIG. 3 shows a method of controlling the composite cooking machine shown in FIG. 2. The method is described below with reference to FIG. 2.

A user sets one of the component cooking machines 200 and 300 to cook and corresponding cooking conditions through the input unit 500 in operation 70. Accordingly, an input instruction is input to the control unit 450 from the input unit 500. The control unit 450 determines whether the set cooking machine is the first component cooking machine 200 by analyzing the input instruction in operation 72. Where it is determined that the set cooking machine is the first component cooking machine 200, the control unit 450 turns on the first switch SW1 and performs a cooking operation by controlling the first component cooking machine 200 according to the set cooking conditions in operation 74.

During the cooking operation of the first component cooking machine 200, the control unit 450 determines whether a key signal has been input in operation 76. Where it is determined that the key signal has not been input in the operation 76, the control unit 450 returns to the operation 74. Where it is determined that the key signal has been input, the control unit 450 determines whether the cooking operation performed by the first component cooking machine 200 has been completed in operation 78. Where it is determined that the cooking operation performed by the first component cooking machine 200 has not been completed, the control unit 450 performs the cooking operation in response to a key signal corresponding to the first component cooking machine 200 in operation 80. At this time, since the control unit 450 does not respond to the key signal input in the operation 76, for example, a key signal corresponding to the second component cooking machine 300, the switch SW2 is maintained at its turned-off state, and power is not supplied to the second component cooking machine 300.

Where it is determined that the cooking operation performed by the first component cooking machine 200 has been completed in the operation 78, the control unit 450 turns off the first switch SW1 in operation 82.

Thereafter, the control unit 450 can perform a cooking operation of any one of the first and second component cooking machines 200 and 300 in response to an input key signal, wherein one of the first and second switches SW1 and SW2 corresponding to the one of the component cooking machines 200 and 300 is turned on to supply power in operation 84.

Where it is determined that the set cooking machine is not the first component cooking machine 200 in the operation 72, the control unit 450 determines whether the set cooking machine is the second component cooking machine 300 in operation 86. Where it is determined that the set cooking machine is not the second component cooking machine 300 in the operation 86, the control unit 450 returns to the operation 70 so as to reset a component cooking machine and cooking conditions.

Where it is determined that the set cooking machine is the second component cooking machine 300 in the operation 86, the control unit 450 turns on the second switch SW2 and performs a cooking operation by controlling the second component cooking machine 300 according to the set cooking conditions in operation 88.

During the cooking operation performed by the second component cooking machine 300, the control unit 450 determines whether a key signal has been input in operation 90. Where it is determined that the key signal has not been input, the control unit 450 returns to the operation 88. Where it is determined that the key signal has been input in the operation 90, the control unit 450 determines whether the cooking operation performed by the second component cooking machine 300 has been completed in operation 92. Where it is determined that the cooking operation performed by the second component cooking machine 300 has not been completed, the control unit 450 performs the cooking operation according to a key signal corresponding to the second component cooking machine 300 in operation 94. At this time, since the control unit 450 does not respond to the key signal input in the operation 90, for example, a key signal corresponding to the first component cooking machine 200, the first switch SW1 is maintained at its turned-off state, and power is not supplied to the first component cooking machine 200.

Where it is determined that the cooking operation performed by the second component cooking machine 300 has been completed in the operation 92, the control unit 450 turns off the second switch SW2 in operation 96. Thereafter, the control unit 450 executes the operation 84 to perform a cooking operation by either one of the first and second component cooking machines 200 and 300 in response to a corresponding key signal input.

As described above, the present invention provides a composite cooking machine which supplies power to only one of component cooking machines, without responding to a key signal for the other component cooking machines(s), where a cooking operation performed by the one component cooking machine is not completed. Therefore, the composite cooking machine of the present invention does not allow simultaneous operations of a plurality of component cooking machines, thus preventing unnecessary operations of a circuit breaker, and consequently increasing the reliability of the composite cooking machine.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A composite cooking machine for use in a cooking area, comprising:
component cooking machines which use a common power source of the cooking area;
a power supply unit which individually supplies power to the component cooking machines;
an input unit which receives cooking information; and
a control unit which controls the power supply unit to operate only one of the component cooking machines in response to the cooking information input through the input unit.

2. The composite cooking machine as set forth in claim 1, wherein:
the power supply unit comprises switches which are connected in series with the component cooking machines between the power source and the component cooking machines, respectively, and
the power is supplied through one of the switches corresponding to the one of component cooking machines being operated.

3. The composite cooking machine as set forth in claim 1, further comprising a circuit breaker which shuts off the power in response to a flow of a current greater than an allowable current through the circuit breaker, wherein the power supply unit supplies the power supplied through the circuit breaker to the corresponding one of the component cooking machines.

4. The composite cooking machine as set forth in claim 1, wherein the component cooking machines are cooking machines which perform different cooking functions.

5. The composite cooking machine as set forth in claim 4, wherein the component cooking machines are implemented as one group of a microwave oven and a coffee maker, a microwave oven and a toaster, a microwave oven and an electric range, and a microwave oven and an air cleaner.

6. The composite cooking machine as set forth in claim 1, wherein the control unit does not respond to a key signal corresponding to a cooking instruction of the cooking information to operate another one of the component cooking machines in response to a cooking operation performed by the one of the component cooking machines not being completed.

7. The composite cooking machine as set forth in claim 1, wherein the composite cooking machine is a wall-mountable composite cooking machine.

8. The composite cooking machine as set forth in claim 2, further comprising a circuit breaker which shuts off the power in response to a flow of a current greater than an allowable current through the circuit breaker, wherein the power supply unit supplies the power supplied through the circuit breaker to the corresponding one of the component cooking machines.

9. The composite cooking machine as set forth in claim 2, wherein the control unit turns on only the one of the switches corresponding to the component cooking machine being operated at a time so as to prevent the other component cooking machines from operating.

10. A composite cooking machine comprising:
a single power supply unit which supplies power to operate the composite cooking machine;
component cooking machines which share the single power supply unit; and
a control unit which controls the single power supply unit and prevents a simultaneous operation of the component cooking machines by not responding to a signal to operate the other component cooking machines in response to an operation of one of the component cooking machines not being completed.

11. The composite cooking machine as set forth in claim 10, further comprising:
an input unit which receives an operating information to operate the composite cooking machine; and
a circuit breaker which shuts off the power in response to a flow of a current greater than an allowable current of the circuit breaker, wherein the single power supply unit supplies the power supplied through the circuit breaker to the corresponding one of the component cooking machines.

12. The composite cooking machine as set forth in claim 10, wherein:
the single power supply unit comprises switches which are connected in series with the component cooking machines between an external power source and the component cooking machines, respectively, and
the control unit turns on only one of the switches corresponding to the component cooking machine being operated so as to prevent the other component cooking machines from operating.

13. The composite cooking machine as set forth in claim 10, wherein the component cooking machines are cooking machines which perform different cooking functions.

14. The composite cooking machine as set forth in claim 10, wherein the composite cooking machine is a wall-mountable composite cooking machine.

15. A method of controlling a composite cooking machine having a single power supply unit which supplies power to operate the composite cooking machine, component cooking machines which share the single power supply unit, and a control unit which controls the single power supply unit and prevents a simultaneous operation of the component cooking machines, the method comprising:
receiving cooking information to operate the composite cooking machine; and
controlling the single power supply unit to operate only one of the component cooking machines in response to an operation of the one of the component cooking machines not being completed.

16. The method as set forth in claim 15, wherein the controlling of the single power supply unit comprises not responding to a signal to operate another one of the component cooking machines in response to the operation of the one of the component cooking machines not being completed.

17. The method as set forth in claim 15, wherein the controlling of the single power supply unit comprises:
determining the one of the component cooking machines to operate in response to the received cooking information;
supplying the power to the one of the component cooking machines while preventing the remaining component cooking machines from receiving the power;
determining whether a signal to operate another one of the component cooking machines is received; and
operating the another one of the component cooking machines after completing the operation of the one of the component cooking machines.

18. The method as set forth in claim 17, wherein the operating the another one of the component cooking machines includes supplying the power to the another one of the component cooking machines while preventing the remaining component cooking machines from receiving the power until an operation corresponding to the another one of the component cooking machines is completed.
